(19) United States
(12) Patent Application Publication
(10) Pub. No.: US 2012/0210909 A1
(43) Pub. Date: Aug. 23, 2012

(54) CALCIM PHOSPHATE CEMENT REINFORCEMENT BY POLYMER INFILTRATION AND IN SITU CURING

(76) Inventors: Tien-Min Gabriel Chu, Carmel, IN (US); Daniel L. Alge, Indianapolis, IN (US)

(21) Appl. No.: 13/031,529

(22) Filed: Feb. 21, 2011

(51) Int. Cl. C04B 28/34; C04B 24/14; B05D 3/02; C04B 24/24

(52) U.S. Cl. 106/645; 524/5; 106/691; 427/393.6

(57) ABSTRACT

The present invention provides a reinforced calcium phosphate cement, comprising a calcium phosphate cement and a reinforcing polymeric material.

### BACKGROUND

Calcium phosphate cements have shown promising results as bone repair materials. Due to their calcium phosphate chemistry, these biomaterials have excellent bioactive and osteoconductive properties [1]. Additionally, in contrast to sintered calcium phosphate ceramics, calcium phosphate cements can be prepared at ambient conditions, and they have a microcrystalline structure which makes them more resorbable [1-3]. The primary advantage of calcium phosphate cements, however, is their ability to be molded to a desired geometry, which has led to their application as bone void filling materials (e.g. in craniofacial reconstruction [4, 5] and verterbroplasty [6]). This property is highly advantageous for bone tissue engineering scaffold fabrication, as it makes calcium phosphate cements amenable to casting based fabrication technologies. Nonetheless, the poor mechanical strength and brittleness of calcium phosphate cements are widely regarded as limitations.

Expanding the utility of calcium phosphate cements provides a strong impetus for studying cement reinforcement. Two distinct methods have been described in the literature. The first is to incorporate a water soluble polymer during cement mixing. A variety of different water soluble polymers have been investigated for calcium phosphate cement reinforcement including gelatin, poly(vinyl alcohol), poly(acrylic acid), chitosan lactate, as well as modified polypeptides [7-11]. The second approach has been to incorporate polymeric fibers into the cement during mixing. Fibers consisting of chitosan, carbon, aramid (i.e. Kevlar®), fiberglass, polyamide, and polygalactin have been investigated [12-15], and they have been used in mesh and single fiber form. For fiber reinforcement the fiber length is as a key variable, and long continuous fibers are most effective at improving cement mechanical properties because of their ability to bridge and deflect cracks [12, 14].

In order for calcium phosphate cements to become useful as bone tissue engineering scaffolds, the reinforcement method must be compatible with scaffold fabrication. The moldability of calcium phosphate cements can be leveraged for scaffold fabrication via indirect casting, which is a lost mold technique based on rapid prototyping technology [16], as this method offers precise control over the three-dimensional (3D) architecture of the scaffold. Unfortunately, incorporating a polymer during cement mixing may be prohibitive to casting. Water soluble polymers can alter the setting time and castability of the cement paste, and polymer fibers could potentially block the channels of the scaffold mold.

### FIGURES

FIG. 1 is a scheme illustrating calcium phosphate cement reinforcement via polymer infiltration and in situ curing.

FIG. 2 illustrates 3D calcium phosphate cement scaffolds. The CAD design (A) correlated well with the final cast product (B). Reinforcement with PEGDA 600 significantly improved the scaffold compressive strength (n=6; p<0.05) (C).

FIG. 3 illustrates EDS element maps from P/L 1.0 cements reinforced with PEGDA 400; 50× magnification. (A) SEM image of the mapped specimen cross-section. Maps showing the distribution of calcium (B) and carbon (C). Carbon was distributed throughout the specimen, similar to calcium, demonstrating that PEGDA infiltrated the cement and did not simply form a shell. The specimen cross-section is 2 mm×2 mm.

FIG. 4 illustrates results from compressive testing. Significance differences within each P/L and PEGDA molecular are indicated by * and † respectively (n=3; p<0.05).

FIG. 5 illustrates results from three point bending testing. Note that cements prepared with P/L of 0.8 and reinforced with PEGDA 400 and 600 did not fail during testing. For these groups, the reported values for flexural strength, maximum displacement, and work of fracture represent values obtained at the cutoff displacement of 2.6 mm. Significance differences within each P/L and PEGDA molecular weight are indicated by * and † respectively (n=3; p<0.05).

FIG. 6 illustrates macroscopic deformation and microcracking. (A) shows a specimen that was deformed due to polymer shrinkage during curing. SEM images of the surfaces showed abundant microcracks, which are indicated by arrows in (B; 50×) and shown at high magnification in (C; 350×). No cracks were found in non-reinforced cements (D).

FIG. 7 illustrates an example method of making a reinforced CPC.

### DEFINITIONS

As used herein, the term “cement” is the product of the setting of a cement mixture resulting from the mixing of one or more cement precursor(s), such as a cement powder, and a solubilizer, such as water or a liquid phase comprising water.

The “setting” of a cement mixture means the spontaneous hardening at room or body temperature of the cement mixture.

A “set cement” may be “partially set” or “fully set.” A “partially set” cement is characterized by a penetration force of at least 1750 psi (12.05 MPa), as measured according to the wet field penetration resistance test described in U.S. Pat. No. 7,459,018 to Murphy et al. A “fully set” cement is characterized by a penetration force of at least 3500 psi (24.1 MPa), as measured according to the wet field penetration resistance test described in U.S. Pat. No. 7,459,018 to Murphy et al.

An “injectable cement mixture” means a cement mixture sufficiently fluid to flow through a needle with a diameter of a few millimeters, preferably between 1 and 5 mm.

A “calcium phosphate cement,” or CPC, is a cement that is the product of the setting of a cement mixture which comprises a compound selected from the group consisting of: calcium phosphate, a compound comprising calcium, a compound comprising phosphate, and mixtures thereof.

The term “calcium” refers to element calcium (Ca) and its ions, such as Ca²⁺.

The term “phosphate” refers to a compound comprising a phosphorus atom bound to four oxygen atoms, such as the phosphate anion PO₄³⁻, the hydrogen phosphate anion HPO₄²⁻, and the dihydrogen phosphate anion H₂PO₄¹⁻.

The term “polymer precursor” refers a compound that will form a polymer, for example when it comes into contact with a corresponding activator for the polymer precursor. Classes of polymer precursors include acrylates, methacrylates, and vinyl compounds such as styrene; precursors of monomers of multi-monomer polymers such as thiols, alcohols and amines; and prepolymers such as oligomers still capable of further polymerization.

The term “activator” refers anything that when contacted or mixed with a reaction mixture can form a polymer. Example activators include catalysts, initiators, and native activating moieties. A corresponding activator for a polymer precursor is an activator that when contacted or mixed with that specific polymer precursor will form a polymer.

The term “catalyst” refers to a compound or moiety that will cause a reaction mixture to polymerize, and is not always consumed each time it causes polymerization. This is in contrast to initiators and native activating moieties.

The term “initiator” refers to a compound that will cause a reaction mixture to polymerize, and is always consumed at the time it causes polymerization.

The term “polymer” refers to a molecule that contains at least 100 repeating units.

The term “polymeric material” refers to a material comprising one or more polymers.

The term “monomer” refers to a repeating unit in a polymer.

### SUMMARY OF THE INVENTION

In a first aspect, the present invention provides a reinforced calcium phosphate cement, comprising a calcium phosphate cement and a reinforcing polymeric material.

In a second aspect, the present invention provides a method of making a reinforced calcium phosphate cement, comprising: forming a cement mixture, casting the cement mixture to set into a mold to form a set cement, contacting the set cement with a polymer precursor, and curing the polymer precursor into a polymeric material.

In a third aspect, the present invention provides a method of making a reinforced calcium phosphate cement, comprising: contacting a calcium phosphate cement with a polymer precursor, and curing the polymer precursor to form polymeric material.

### DETAILED DESCRIPTION

The present application is based on the discovery of a novel, alternative approach to calcium phosphate cement reinforcement that includes saturating the fully set cement with a reactive polymer precursor and then polymerizing the precursor in situ. This approach exploits the microporosity of calcium phosphate cements and can be used to reinforce a pre-set cement structure. Thus, it does not interfere with the indirect casting process and can be used for the reinforcement of 3D macroporous calcium phosphate cement scaffolds with complex architectures.

In one aspect, the present invention provides novel reinforced CPCs comprising a CPC and a reinforcing polymeric material. The CPC may be any of those already known in the art, such as those obtained from aqueous slurries of calcium phosphate. Preferred CPCs include those obtained from mixtures comprising beta-tricalcium phosphate and phosphoric acid and those obtained from mixtures comprising beta-tricalcium phosphate and pyrophosphoric acid (H₄P₂O₇) [38]. Other preferred CPCs include those obtained from mixtures comprising tetracalcium phosphate (Ca₄(PO₄)₂O, TTCP) and at least one of dicalcium phosphate dihydrate (CaHPO₄.2H₂O, DCPD), anhydrous dicalcium phosphate (CaHPO₄, DCPA), octacalcium phosphate (Ca₈H₂(PO₄)₆.5H₂O, OCP), α-Ca₃(PO₄)₂ (alpha-tricalcium phosphate, β-Ca₃(PO₄)₂ (beta-tricalcium phosphate), amorphous calcium phosphate, and Ca₃(PO₄)₂ modified by the addition of protons or up to approximately 10% magnesium by weight (whitlockite), as taught for example by Brown et al. in U.S. Pats. Nos. Re. 33,161 and Re. 33,221 and by Chow et al. in U.S. Pat. No. 5,522,893. Most preferred are CPCs obtained from mixtures comprising monocalcium phosphate monohydrate (Ca(H₂PO₄)₂.H₂O; MCPM) and beta-tricalcium phosphate (β-Ca₃(PO₄;β-TCP) [21].

The reinforcing polymeric material comprises at least one polymer and/or copolymer. The reinforcing polymeric material is not part of the cement mixture from which the CPC is derived; rather, it is located in the void spaces in the CPC. Preferred polymers include natural and synthetic polymers commonly used in biomedical applications. Examples include polyesters, polyanhydrides, polyols, polysaccharides, proteoglycans, modified peptides, and modified proteins. Preferred polymers include gelatin, poly(vinyl alcohol) (PVA), poly(acrylic acid) (PAA), polylactic acid (polylactide, PLA), poly(methyl methacrylate) (PMMA), polypropylene fumarate (PFF), poly(DL-lactic-co-glycolic acid), poly(methyl vinyl ether-co-maleic acid), and polyethylene (glycol) diacrylate (PEGDA).

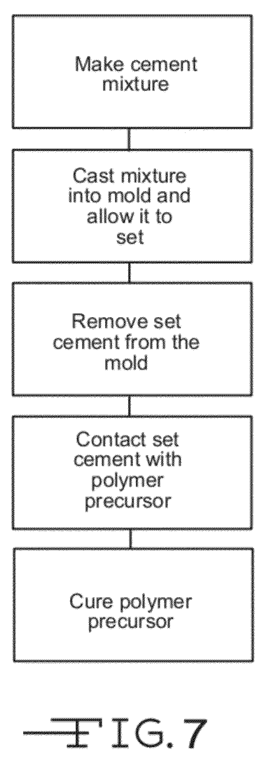

In a second aspect, the present invention provides methods for manufacturing a reinforced CPC comprising a CPC and a reinforcing polymeric material. A representative example of such methods is illustrated in FIG. 7. A cement mixture is first forming by mixing ingredients such as a cement powder and liquid component(s), e.g. an aqueous solution, and the mixture is cast into a mold and allowed to set, preferably until it is fully set. The set cement is then removed from the mold, preferably dried under vacuum, and then contacted with a polymer precursor and, optionally, an activator. Curing the polymer precursor completes the process.

The cement mixture comprises a compound selected from the group consisting of: calcium phosphate, a compound comprising calcium, a compound comprising phosphate, and mixtures thereof. Preferred mixtures include those comprising beta-tricalcium phosphate and phosphoric acid and those comprising beta-tricalcium phosphate and pyrophosphoric acid (H₄P₂O₇) [38]. Other preferred mixtures include those comprising tetracalcium phosphate (Ca₄(PO₄)₂O, TTCP) and at least one of dicalcium phosphate dihydrate (CaHPO₄.2H₂O, DCPD), anhydrous dicalcium phosphate (CaHPO₄, DCPA), octacalcium phosphate (Ca₈H₂(PO₄)₆.5H₂O, OCP), α-Ca₃(PO₄)₂ (alpha-tricalcium phosphate, β-Ca₃(PO₄)₂ (beta-tricalcium phosphate), amorphous calcium phosphate, and Ca₃(PO₄)₂ modified by the addition of protons or up to approximately 10% magnesium by weight. Most preferred are mixtures comprising monocalcium phosphate monohydrate (Ca(H₂PO₄)₂.H₂O; MCPM) and beta-tricalcium phosphate (β-Ca₃(PO₄)₂; β-TCP) [21].

Various additives may be included to the cement mixture to adjust the properties of the resulting CPC, for example: additional calcium- and phosphate-containing compounds to adjust the calcium to phosphorus (Ca/P) ratio, pH modifiers such as acids and bases; proteins; medicaments; supporting or strengthening filler materials; crystal growth adjusters; viscosity modifiers, pore forming agents and other additives may be incorporated without departing from the scope of this invention. Example modifiers include sodium pyrophosphate (Na₂P₄O₇) and sulfuric acid, which may be added to optimize the setting time and mechanical strength of cements [36]. Sulfate, pyrophosphates, and citrates have also been shown to influence the setting time and tensile strength of the cements made of beta-tricalcium phosphate and phosphoric acid [37].

The amount of polymer present in the product reinforced CPC can be changed by adjusting the relative amounts of solid to liquid ingredients in the cement mixture. For example, if the cement mixture is obtained by mixing ingredients comprising a cement powder and a liquid, changes in the cement powder to liquid mass ratio, or P/L, are reflected by changes in the amount of reinforcing polymer present in the product reinforced CPC. As the porosity of the CPCs is usually inversely proportional to the P/L, that is higher amounts of cement powder leads to lower levels of porosity, the amount of polymer that can infiltrate the pores of the CPC tends to decrease as P/L increases, and vice versa. Therefore, reinforced CPCs with mechanical properties tailored to specific requirements can be obtained.

The properties of the polymer precursor, for instance its number of monomers, can also be used to obtain reinforced CPCs with different mechanical properties. For example, it appears that increasing the number of monomers in a polymer precursor leads to reinforced CPCs with more robust compressive and flexural properties. Without being bound to any particular theory, it is believed that increasing the number of monomers in a polymer precursor leads to larger, stronger polymers and thus to better reinforced CPCs. Preferably, the polymer precursor has a molecular weight of at least 50 to at most 2000 Daltons. More preferably, the polymer precursor has a molecular weight of at least 100 to 1000 Daltons. Most preferably, the polymer precursor has a molecular weight of at least 200 to at most 600 Daltons.

The polymer precursor is infiltrated in the set CPC, for example by immersing the CPC in a solution comprising the precursor, or by spraying/pipetting the solution on the CPC. If an activator is needed to start the polymerization reaction, it can for instance be included in the precursor solution. Excessive polymer precursor is preferably removed from the CPC, for example by blotting, and the polymerization is carried out, yielding the product reinforced CPC.

### Example 1

### Materials and Methods

Calcium Phosphate Cement Preparation

Calcium phosphate cement was prepared using monocalcium phosphate monohydrate (MCPM; Strem Chemicals, Newburyport, MA, USA) and β-tricalcium phosphate (β-TCP; Plasma Biotal Limited, North Derbyshire, England). This cement system has been studied extensively, and was chosen because dicalcium phosphate dihydrate (DCPD, also known as brushite) is the setting product [20-23]. DCPD is a highly resorbable calcium phosphate, and therefore is of interest for the fabrication of degradable bone tissue engineering scaffolds. All cements were prepared with a 1:1 MCPM:β-TCP molar ratio and deionized water.

To demonstrate 3D scaffold reinforcement, commercial CAD software (Rhinoceros, McNeel North America, Seattle, Wash., USA) was used to design a cylindrical scaffold (8 mm diameter×8.5 mm height) comprised of orthogonally intersecting 1 mm diameter cylindrical beams spaced 750 μm apart. The macroporosity of this design was calculated to be 46.97 percent. Negative wax molds of the scaffold were manufactured on a Solidscape T66 benchtop rapid prototyping machine (Solidscape, Merrimack, N.H., USA). DCPD cement was then prepared with a P/L of 1.0 and scaffolds were cast by pressing the mold into the unhardened cement paste. After allowing the cement to set for approximately 30 min, the wax mold was dissolved in acetone to reveal the scaffold. Additionally, specimens with cylindrical (3.5 mm diameter×7 mm height) and bar-shaped (25 mm×3.5 mm×2 mm) geometries were made by pressing the unhardened cement paste into appropriately sized molds. These specimens were prepared with P/L of 0.8, 1.0, and 1.43 to investigate the effects of this variable. The specimens were allowed to set for approximately 10-30 min prior to mold removal, depending on the P/L.

Polymer Reinforcement

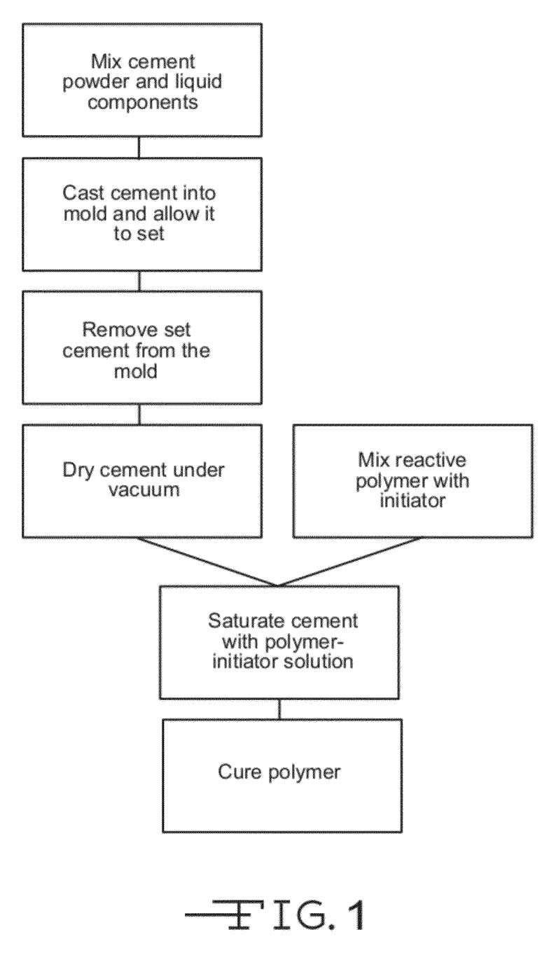

Polymer reinforced calcium phosphate cement was prepared using the method outlined in the schematic in FIG. 1. Prior to reinforcement the cements were vacuum dried in a dessicator chamber at 25° C. for two days. The specimens were then saturated with solutions of PEGDA containing 5 wt % benzoyl peroxide initiator (Acros Organics, Geel Belgium). For 3D scaffold reinforcement the specimens were submerged in a PEGDA solution for 3 min at ambient pressure. Only 600 Dalton nominal molecular weight PEGDA was used. Excess PEGDA was removed by blotting and gently blowing air through the scaffold. For the cylindrical and bar shaped specimens, the cements were saturated by pipetting PEGDA solution onto the surface of the cements until no more could be absorbed. Solutions containing 200, 400 and 600 Dalton nominal molecular weight PEGDA were used (Sartomer Company, Exton, Pa., USA). To ensure that reinforcement was due to polymer infiltration and not simply the formation of a polymeric shell, excess PEGDA was blotted away from the surface. All specimens were cured at 80° C. for 24 h.

Evaluation of PEGDA Incorporation

Mass change after curing normalized to specimen volume was utilized as a quantitative measure of polymer incorporation. The results were correlated to cement porosity, which was calculated by the equation porosity=(1−ρₛₐₘₚₗₑ/ρ_{DCPD})×100%, where ‘ρsample’ is the bulk density of the cement specimen and ‘ρ_{DCPD}’ is the theoretical density of DCPD, which is 2.318 g/cm³ [24]. To demonstrate that PEGDA infiltrated the micropores of the cement, the bar-shaped specimens were bisected and energy dispersive spectroscopy (EDS) was used to generate element maps for calcium and carbon and visualize their distribution throughout the cross-sections. EDS was performed on a Jeol JSM-5310LV scanning electron microscope (SEM; Jeol, Tokyo, Japan) equipped with a liquid nitrogen cooled silicone-lithium compact detector unit (EDAX, Mahwah, N.J., USA). Analysis of uncoated specimens was performed at 10 kV accelerating voltage. Element maps were collected in EDAX DX4 software by specifying regions of interest corresponding to the K_{α} emission ranges for calcium and carbon, which were arbitrarily chosen to be represented in red and yellow respectively. SEM was also used to characterize the effects of PEGDA incorporation on cement microstructure, as some samples were noted to have undergone macroscopic deformation after curing. For SEM, specimens were gold coated and imaged at 15 kV accelerating voltage.

### Mechanical Testing

Mechanical properties of reinforced and non-reinforced control specimens were evaluated on a universal materials testing machine (MTS Systems, Eden Prarie, Minn., USA). All specimens were loaded at a rate of 1 mm/min. The 3D scaffolds were loaded in compression to determine the scaffold compressive strength. The cylindrical specimens were tested in compression to determine compressive strength and compressive failure strain. The bar shaped specimens were loaded in three point bending using a span of 15 mm. Flexural strength was calculated using the equation σ_{strength}=Mc/l, where ‘M’ is the maximum applied moment during testing, ‘c’ is one half of the sample thickness, and ‘I’ is the area moment of inertia. Flexural modulus was calculated as E_{flex}=mL³/48L, where ‘m’ is the slope of the force-displacement curve up to the proportional limit and 1′ is the testing span. Work of fracture was calculated as the energy absorbed to failure, normalized to the specimen cross-sectional area. Maximum displacement during testing was also measured. Due to the high ductility of the P/L of 0.8 cements reinforced with PEGDA 400 and 600, three point bending testing was stopped at a displacement of 2.6 mm. Thus, failure did not occur in these groups and values for flexural strength and work of fracture are not reported.

### Statistical Analysis

Data are presented as the mean plus or minus the standard deviation. Statistical analysis was performed using SAS version 9.1 (α=0.05 for all experiments). Welch's t-test was used to compare compressive strength between reinforced and non-reinforced scaffolds. The effect of P/L on cement porosity was evaluated using a one-way ANOVA. The effects of P/L and PEGDA molecular weight on PEGDA incorporation, as well as the compressive and flexural properties of reinforced cement was analyzed using an ANOVA two factor mixed effects model. Significance between groups was determined by post hoc comparisons using Tukey's method. A Tukey-Kramer test was used when variances were unequal.

### Results

Proof of Concept for 3D Scaffold Reinforcement

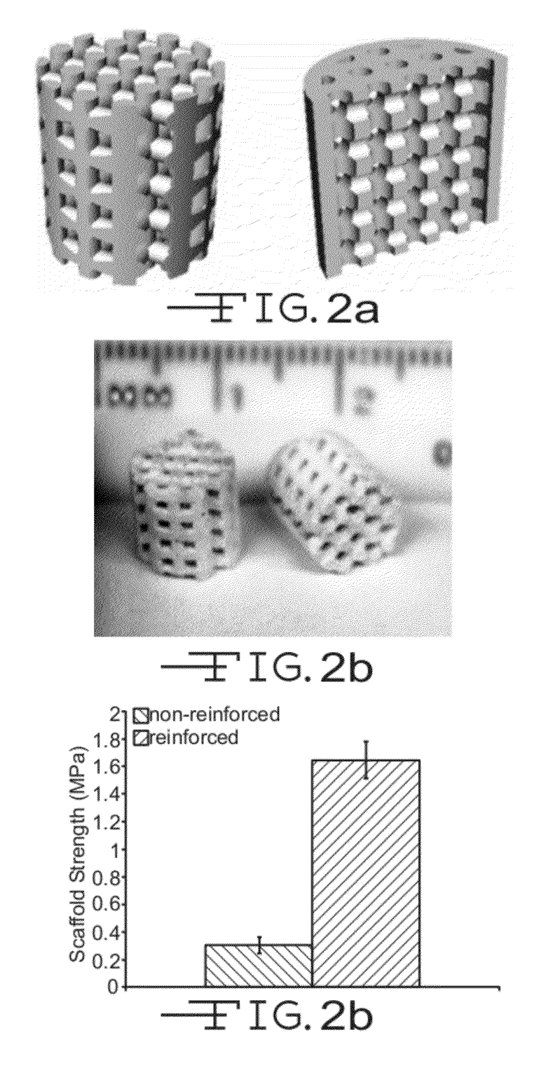

Polymer saturation and in situ curing was utilized to reinforce pre-set 3D calcium phosphate cement scaffolds comprised of orthogonally intersecting cylindrical beams. The scaffolds were prepared using an indirect casting approach, which offers precise control over the scaffold architecture. The final products correlated well with the scaffold design and did not have any macroscopic flaws (FIGS. 2A and 2B). No excess polymer was present in the scaffold channels after curing, which was verified by passing a smaller diameter wire through the scaffold channels. Compressive testing showed that reinforcement with PEGDA 600 significantly increased the compressive strength from 0.31±0.06 MPa to 1.65±0.13 MPa compared to non-reinforced controls (FIG. 2C; p<0.05).

Effect of Porosity on PEGDA Incorporation

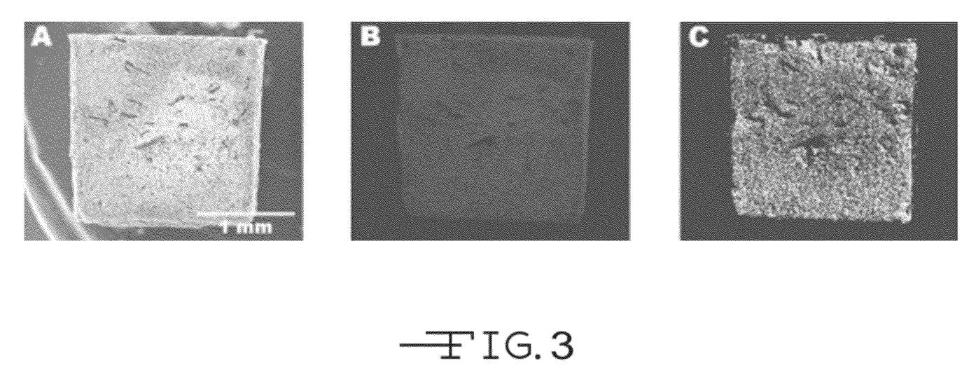

As expected, the effect of P/L on percent porosity of cement was significant (p<0.05). The P/L of 0.8, 1.0, and 1.43 groups had porosities of 63.33±3.18 percent, 58.35±2.45, percent, and 48.36±1.08 percent respectively. The differences in porosity led to a significant effect on PEGDA incorporation. For example, the amount of PEGDA 600 incorporated decreased from 0.82±0.07 mg/mm³ to 0.52±0.01 mg/mm³ as the P/L increased from 0.8 to 1.43 (Table 1). The differences between P/L of 0.8 and 1.43 were significant for all three PEGDA molecular weights (p<0.05). PEGDA molecular weight, however, did not have a significant effect on PEGDA incorporation (p>0.05). EDS element mapping of specimen cross-sections revealed that carbon was distributed throughout the specimens, regardless of P/L and PEGDA molecular weight, thereby verifying that PEGDA infiltrated the cement microstructure (FIG. 3).

TABLE I
Effect of Porosity and Molecular Weight
on PEGDA Incorporation

| | | | Mass of |
|---|---|---|---|
| | | PEGDA | PEGDA |
| P/L | Percent | Molecular | Incorporated |
| Ratio | Porosity | Weight | (mg/mm³) |
| 0.8 | 63.33 ± 3.18 | 200 | 0.73 6 0.04 |
| | | 400 | 0.80 6 0.02 |
| | | 600 | 0.82 6 0.07 |
| 1.0 | 58.35 ± 2.45 | 200 | 0.68 6 0.02 |
| | | 400 | 0.68 6 0.03^{a} |
| | | 600 | 0.72 6 0.04^{a} |
| 1.43 | 48.36 ± 1.08 | 200 | 0.54 6 0.02^{a} |
| | | 400 | 0.58 6 0.11 |
| | | 600 | 0.52 6 0.01^{a} |

P/L had a significant effect on percent porosity and PEGDA incorporation (p < 0.05).
Molecular weight did not have a significant effect on PEGDA incorporation (p ¼ 0.09).
^{a}Significant decreases compared to the same molecular weight at a lower P/L (p < 0.05).

Effects of P/L and PEGDA Molecular Weight on Compressive Properties

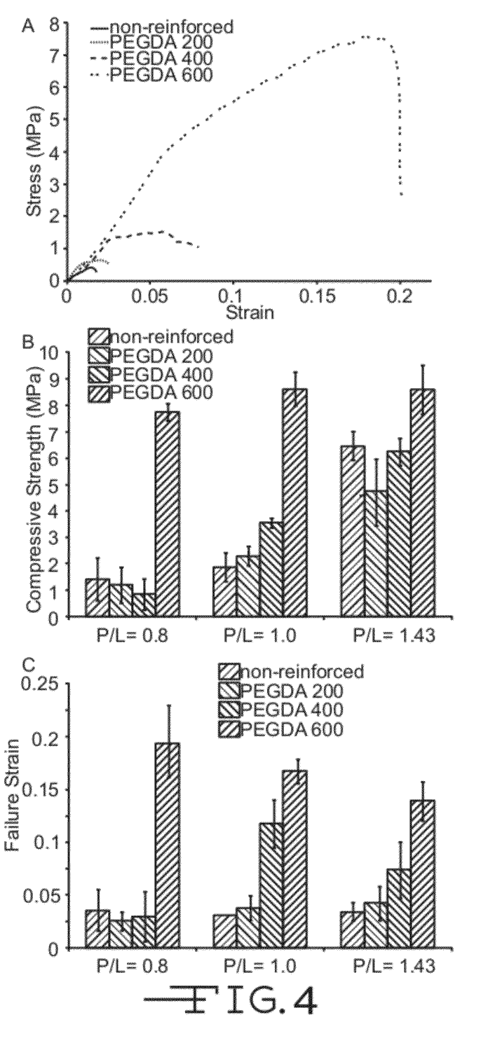

Polymer reinforcement had a marked effect on the compressive properties of the calcium phosphate cement (FIG. 4). At P/L of 0.8 the compressive strength of the non-reinforced cement was 1.40±0.84 MPa. A significant increase was only observed for the PEGDA 600 group, which had a compressive strength of 7.74±0.33 MPa (p<0.05). Similarly, at P/L of 1.0 the non-reinforced and PEGDA 200 groups had compressive strengths of about 2 MPa, whereas the PEGDA 400 and PEGDA 600 groups were significantly increased to 3.55±0.18 MPa (p<0.05) and 8.61±0.64 MPa (p<0.05) respectively. At P/L of 1.43 the non-reinforced cement had a compressive strength of 6.43±0.58 MPa. A significant increase was only seen for the PEGDA 600 group, which had a compressive strength of 8.58±0.92 MPa (p<0.05). While non-reinforced cements generally had very low failure strains of approximately 0.04, PEGDA 600 reinforcement significantly improved the failure strain to the range of 0.15 to 0.2 (p<0.05). PEGDA 400 also increased failure strain in the P/L of 1.0 and 1.43 groups, but the increases were lower than what was observed for PEGDA 600 reinforcement.

Effects of P/L and PEGDA Molecular Weight on Flexural Properties

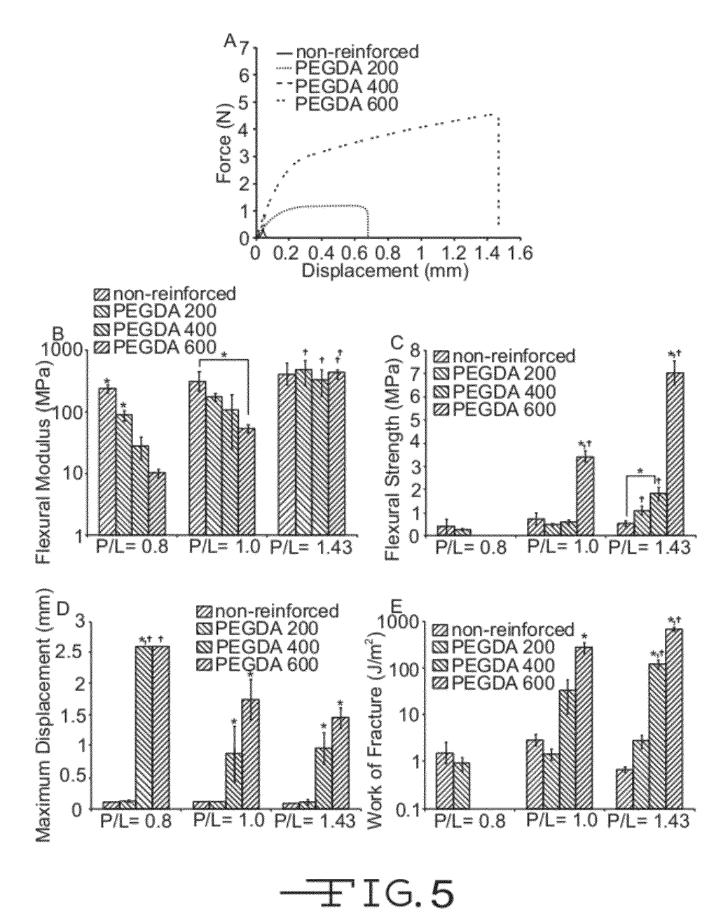

Polymer reinforcement also had a marked effect on the flexural properties (FIG. 5). Flexural strength was very low for the non-reinforced cements (˜0.5 MPa), illustrating their brittleness. PEGDA 200 had little effect, but large increases were seen for PEGDA 400 and 600. At P/L of 1.43 the PEGDA 400 group had a flexural strength of 1.82±0.29 MPa (p<0.05 compared to the control). More dramatic increases were seen with PEGDA 600 reinforcement. At P/L of 1.0 PEGDA 600 significantly increased the flexural strength to 3.41±0.42 MPa, and at 1.43 it was further increased to 7.04±0.51 MPa (p<0.05). The trends for maximum displacement during flexural testing were similar to what was observed for compressive strain, except that the PEGDA 400 and 600 groups did not fail at P/L of 0.8. Non-reinforced controls only reached 0.05 mm before failure. At P/L of 1.0 maximum displacement was increased to 1.74±0.33 mm for the PEGDA 600 group (p<0.05). A smaller increase compared to the non-reinforced control was seen for the PEGDA 400 group (0.86±0.45 mm). Differences between the P/L 1.0 and 1.43 groups were not significant. Finally, work of fracture, which is a measure of the energy absorbed prior to failure normalized to cross-sectional area, was only about 1-2 J/m² for the non-reinforced controls but was greatly increased for the PEGDA 400 and PEGDA 600 groups. At P/L of 1.43, the PEGDA 400 group had a work of fracture of 120.35±26.00 J/m2 (p<0.05). Even greater increases were seen for PEGDA 600. At P/L of 1.0 and 1.43 PEGDA 600 reinforcement increased work of fracture to 405.91±66.23 J/m² and 677.96±70.88 J/m² (p<0.05) respectively.

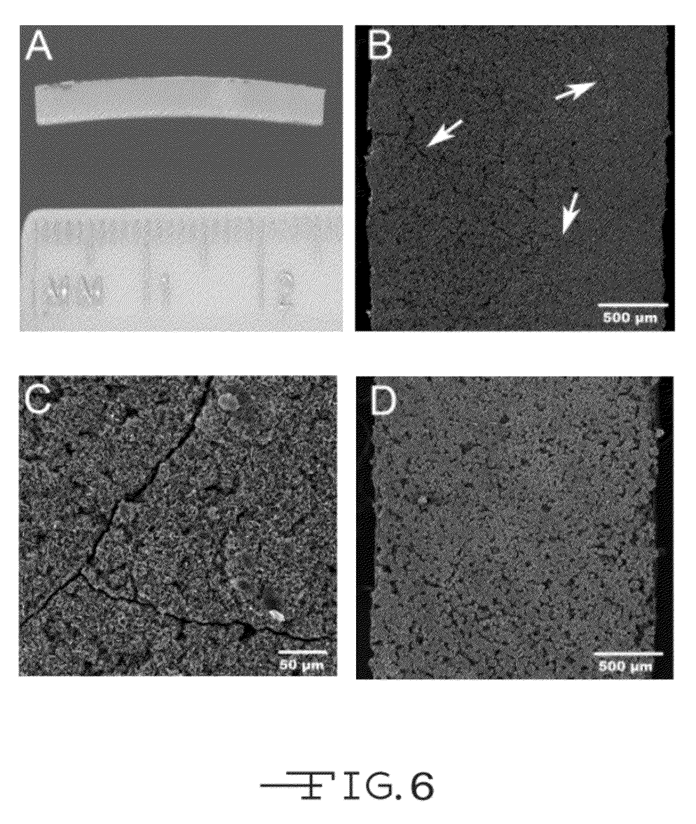

Some of the three point bending specimens were noted to have undergone macroscopic deformation after PEGDA curing (FIG. 6A). SEM images revealed an abundance of microcracks on the surfaces of reinforced specimens prepared with P/L of 0.8 and 1.0 (FIGS. 6B and 6C), while non-reinforced specimens presented no cracks (FIG. 6D). Notably, flexural modulus (FIG. 5B) tended to be reduced by polymer reinforcement at these P/L, and at P/L of 0.8 the PEGDA 400 and 600 reinforced groups did not fail. At P/L of 0.8 the PEGDA 600 reinforced group had a modulus of only 10.14±1.45 MPa (p<0.05). In contrast, all of the groups had moduli in the range of 250±350 MPa at P/L 1.43 and few cracks were apparent in SEM images for these groups.

In summary, the results of this experiment clearly demonstrate the effectiveness of the reinforced CPCs of the invention. For example, flexural strength was improved from 0.5 MPa to as much as 7 MPa. Work of fracture was increased from only 1.5 J/m² to 700 J/m², demonstrating a marked ability of the reinforced cement to resist brittle fracture.

### REFERENCES

1. LeGeros R Z. Properties of osteoconductive biomaterials: calcium phosphates. Clin Orthop Relat Res 2002; (395):81-98.
2. Chow L C. Calcium phosphate materials: reactor response. Adv Dent Res 1988; 2(1):181-4; discussion 185-6.
3. Schmitz J P, Hollinger J O, Milam S B. Reconstruction of bone using calcium phosphate bone cements: a critical review. J Oral Maxillofac Surg 1999; 57(9):1122-6.
4. David L, Argenta L, Fisher D. Hydroxyapatite cement in pediatric craniofacial reconstruction. J Craniofac Surg 2005; 16(1):129-33.
5. Baker S B, Weinzweig J, Kirschner R E, Bartlett S P. Applications of a new carbonated calcium phosphate bone cement: early experience in pediatric and adult craniofacial reconstruction. Plast Reconstr Surg 2002; 109(6):1789-96.
6. Grafe I A, Baier M, Noldge G, Weiss C, D a Fonseca K, Hillmeier J, Libicher M, Rudofsky G, Metzner C, Nawroth P and others. Calcium-phosphate and polymethylmethacrylate cement in long-term outcome after kyphoplasty of painful osteoporotic vertebral fractures. Spine 2008; 33(11):1284-90.
7. Miyazaki K, Horibe T, Antonucci J M, Takagi S, Chow L C. Polymeric calcium phosphate cements: analysis of reaction products and properties. Dent Mater 1993; 9(1):41-5.
8. Majekodunmi A O, Deb S, Nicholson J W. Effect of molecular weight and concentration of poly(acrylic acid) on the formation of a polymeric calcium phosphate cement. J Mater Sci Mater Med 2003; 14(9):747-52.
9. Chen W C, Ju C P, Wang J C, Hung C C, Chem Lin J H. Brittle and ductile adjustable cement derived from calcium phosphate cement/polyacrylic acid composites. Dent Mater 2008; 24(12):1616-22.
10. Xu H H, Quinn J B, Takagi S, Chow L C. Processing and properties of strong and non-rigid calcium phosphate cement. J Dent Res 2002; 81(3):219-24.
11. Lin J, Zhang S, Chen T, Liu C, Lin S, Tian X. Calcium phosphate cement reinforced by polypeptide copolymers. J Biomed Mater Res B Appl Biomater 2006; 76(2):432-9.
12. Xu H H, Eichmiller F C, Barndt P R. Effects of fiber length and volume fraction on the reinforcement of calcium phosphate cement. J Mater Sci Mater Med 2001; 12(1):57-65.
13. Pan Z, Jiang P, Fan Q, Ma B, Cai H. Mechanical and biocompatible influences of chitosan fiber and gelatin on calcium phosphate cement. J Biomed Mater Res B Appl Biomater 2007; 82(1):246-52.
14. Xu H H, Eichmiller F C, Giuseppetti A A. Reinforcement of a self-setting calcium phosphate cement with different fibers. J Biomed Mater Res 2000; 52(1):107-14.
15. dos Santos L A, de Oliveira L C, da Silva Rigo E C, Carrodeguas R G, Boschi A O, Fonseca de Arruda A C. Fiber reinforced calcium phosphate cement. Artif Organs 2000; 24(3):212-6.
16. Chu T M, Halloran J W, Hollister S J, Feinberg S E. Hydroxyapatite implants with designed internal architecture. J Mater Sci Mater Med 2001; 12(6):471-8.
17. Peter S J, Miller S T, Zhu G, Yasko A W, Mikos A G. In vivo degradation of a poly(propylene fumarate)/beta-tricalcium phosphate injectable composite scaffold. J Biomed Mater Res 1998; 41(1):1-7.
18. Timmer M D, Sheongbong J, Wang C, Ambrose C G, Mikos A G. Characterization of the cross-linked structure of fumarate-based degradable polymer networks. Macromolecules 2002; 35:4373-79.
19. Yaszemski M J, Payne R G, Hayes W C, Langer R, Mikos A G. In vitro degradation of a poly(propylene fumarate)-based composite material. Biomaterials 1996; 17(22):2127-30.
20. Theiss F, Apelt D, Brand B, Kutter A, Zlinszky K, Bohner M, Matter S, Frei C, Auer J A, Von Rechenberg B. Biocompatibility and resorption of a brushite calcium phosphate cement. Biomaterials 2005; 26(21):4383-94.
21. Mirtchi A A, Lemaitre J, Terao N. Calcium phosphate cements: study of the beta-tricalcium phosphate—monocalcium phosphate system. Biomaterials 1989; 10(7):475-80.
22. Bohner M, Van Landuyt P, Merkle H P, Lemaitre J. Composition effects on the pH of a hydraulic calcium phosphate cement. J Mater Sci Mater Med 1997; 8(11):675-81.
23. Barralet J E, Grover L M, Gbureck U. Ionic modification of calcium phosphate cement viscosity. Part II: hypodermic injection and strength improvement of brushite cement. Biomaterials 2004; 25(11):2197-203.
24. Elliott J C. General chemistry of the calcium orthophosphates. Structure and chemistry of the apatites and other calcium orthophosphates. Amsterdam, The Netherlands: Elsevier Science; 1994. p 1-62.
25. Apelt D, Theiss F, El-Warrak A O, Zlinszky K, Bettschart-Wolfisberger R, Bohner M, Matter S, Auer J A, von Rechenberg B. In vivo behavior of three different injectable hydraulic calcium phosphate cements. Biomaterials 2004; 25(7-8):1439-51.
26. Hollister S J. Porous scaffold design for tissue engineering. Nat Mater 2005; 4(7):518-24.
27. Hutmacher D W, Sittinger M, Risbud M V. Scaffold-based tissue engineering: rationale for computer-aided design and solid free-form fabrication systems. Trends Biotechnol 2004; 22(7):354-62.
28. Hollister S J, Lin C Y, Saito E, Lin C Y, Schek R D, Taboas J M, Williams J M, Partee B, Flanagan C L, Diggs A and others. Engineering craniofacial scaffolds. Orthod Craniofac Res 2005; 8(3):162-73.
29. Bohner M, Baroud G. Injectability of calcium phosphate pastes. Biomaterials 2005; 26(13):1553-63.
30. Chu T M, Warden S J, Turner C H, Stewart R L. Segmental bone regeneration using a load-bearing biodegradable carrier of bone morphogenetic protein-2. Biomaterials 2007; 28(3):459-467.
31. Ishikawa K, Asaoka K. Estimation of ideal mechanical strength and critical porosity of calcium phosphate cement. J Biomed Mater Res 1995; 29(12):1537-43.
32. Alge D L, Santa Cruz G, Goebel W S, Chu T M. Characterization of dicalcium phosphate dihydrate cements prepared using a novel hydroxyapatite-based formulation. Biomed Mater 2009; 4(2):25016.
33. Metz J, Sargent P, Chu T M. Bovine albumin release and degradation analysis of dicalcium phosphate dihydrate cement. Biomed Sci Instrum 2006; 42:296-301.
34. Chu T M, Warden S J, Turner C H, Stewart R L. Segmental bone regeneration using a load-bearing biodegradable carrier of bone morphogenetic protein-2. Biomaterials 2007; 28(3):459-67.
35. Peter S J, Yaszemski M J, Suggs L J, Payne R G, Langer R, Hayes W C, Unroe M R, Alemany L B, Engel P S, Mikos A G. Characterization of partially saturated poly(propylene fumarate) for orthopaedic application. J Biomater Sci Polym Ed 1997; 8(11):893-904.
36. Van Landuyt P, Lowe C and Lemaitre J, Optimization of setting time and mechanical strength of β-TCP/MPCM cements. Bioceramics 1997; 10: 477-480.
37. Bohner M, Lemaitre J, Effects of sulfate, pyrophosphate, and citrate ions on the physicochemical properties of cements made of β-tricalcium phosphate—phosphoric acid—water mixtures. J. Am. Chem. Soc. 1996; 79 (6): 1427—34.
38. Grover L M, Gbureck U, Wright A J, Tremayne M, Barralet J E, Biologically mediated resorption of brushite cement in vitro. Biomaterials 2006; 27: 2178-85.

1. A reinforced CPC, comprising a CPC and a reinforcing polymeric material.

2. The reinforced CPC of claim 1, wherein the CPC is obtained from a mixture comprising monocalcium phosphate monohydrate and beta-tricalcium phosphate.

3. The reinforced CPC of claim 1, wherein the CPC is obtained from a mixture comprising tetracalcium phosphate and at least one of dicalcium phosphate dihydrate, anhydrous dicalcium phosphate, octacalcium phosphate, alpha-tricalcium phosphate, beta-tricalcium phosphate, amorphous tricalcium phosphate, and whitlockite.

4. The reinforced CPC of claim 1, wherein the CPC is obtained from a slurry of calcium phosphate.

5. The reinforced CPC of claim 1, wherein the CPC is obtained from a mixture comprising beta-tricalcium phosphate and phosphoric acid.

6. The reinforced CPC of claim 1, wherein the CPC is obtained from mixtures comprising beta-tricalcium phosphate and pyrophosphoric acid.

7. The reinforced CPC of claim 1, wherein the reinforcing polymeric material comprises a polymer selected from the group consisting of polyesters, polyanhydrides, polyols, polysaccharides, proteoglycans, peptides, proteins, and mixtures thereof.

8. The reinforced CPC of claim 1, wherein the reinforced polymeric material comprises one of gelatin, poly(vinyl alcohol) (PVA), poly(acrylic acid) (PAA), polylactic acid (polylactide, PLA), poly(methyl methacrylate) (PMMA), polypropylene fumarate (PFF), poly(DL-lactic-co-glycolic acid), poly(methyl vinyl ether-co-maleic acid), polyethylene (glycol) diacrylate (PEGDA), and mixtures thereof.

9. An article of manufacture comprising the reinforced CPC of claim 1.

10. A method of making a reinforced CPC, comprising:
forming a cement mixture;
casting the cement mixture to set into a mold to form a set cement;
contacting the set cement with a polymer precursor, and
curing the polymer precursor to form a polymeric material.

11. The method of claim 10, further comprising drying the set cement under vacuum.

12. The method of claim 10, further comprising contacting the set cement with an activator.

13. The method of claim 10, wherein the cement mixture is formed by mixing ingredients comprising beta-tricalcium phosphate and phosphoric acid.

14. The method of claim 10, wherein the cement mixture is formed by mixing ingredients comprising beta-tricalcium phosphate and pyrophosphoric acid.

15. The method of claim 10, wherein the cement mixture is formed by mixing ingredients comprising tetracalcium phosphate and at least one of dicalcium phosphate dihydrate, anhydrous dicalcium phosphate, octacalcium phosphate, alpha-tricalcium phosphate, beta-tricalcium phosphate, amorphous calcium phosphate, and whitlockite.

16. The method of claim 10, wherein the cement mixture is formed by mixing ingredients comprising monocalcium phosphate monohydrate and beta-tricalcium phosphate.

17. The method of claim 10, wherein the cement mixture is formed by mixing ingredients comprising an additive selected from the group consisting of: pH modifiers, proteins; medicaments, filler materials, crystal growth adjusters, viscosity modifiers, pore forming agents, and mixtures thereof.

18. The method of claim 10, wherein the polymer precursor has a molecular weight of at least 50 to at most 2000 Daltons.

19. The method of claim 10, wherein the polymer precursor has a molecular weight of at least 100 to at most 700 Daltons.

20. The method of claim 10, wherein the polymer precursor has a molecular weight of at least 200 to at most 600 Daltons.

21. A reinforced CPC made according to method of claim 10.

22. A method of making a reinforced CPC, comprising:
contacting a CPC with a polymer precursor, and
curing the polymer precursor to form a polymeric material.

23. A reinforced CPC made according to the method of claim 22.
